(19) United States
(12) Patent Application Publication
(10) Pub. No.: US 2026/0135958 A1
(43) Pub. Date: May 14, 2026

(54) ULTRASONIC DEVICE, MULTI-FEED DETECTOR, CONVEYING DEVICE, AND SCANNER

(71) Applicant: SEIKO EPSON CORPORATION, Tokyo (JP)

(72) Inventors: Hiroto TOMIOKA, SHIOJIRI-SHI (JP); Masayoshi YAMADA, SHIOJIRI-SHI (JP); Seiji IZUO, SHIOJIRI-SHI (JP)

(21) Appl. No.: 19/382,364

(22) Filed: Nov. 7, 2025

(30) Foreign Application Priority Data
Nov. 11, 2024 (JP) 2024-196889

(51) Int. Cl. H04N 1/00; B65H 7/12; B65H 9/20

(52) U.S. Cl. CPC H04N 1/00549; B65H 7/125; B65H 9/20; H04N 1/00018; B65H 2553/30

(57) ABSTRACT

An ultrasonic device includes an ultrasonic element having an ultrasonic wave transmission and reception surface that performs at least one of transmission of ultrasonic waves and reception of ultrasonic waves, and a housing that houses the ultrasonic element, wherein the housing has a reflection surface that reflects the ultrasonic waves, a waveguide that propagates the ultrasonic waves, and an opening provided at one end of the waveguide, through which the ultrasonic waves pass, and a length of the waveguide is longer than a width of the waveguide.

The present application is based on, and claims priority from JP Application Serial Number 2024-196889, filed Nov. 11, 2024, the disclosure of which is hereby incorporated by reference herein in its entirety.

### BACKGROUND

### 1. Technical Field

The present disclosure relates to an ultrasonic device, a multi-feed detector, a conveying device, and a scanner.

### 2. Related Art

For example, JP-A-2020-25242 discloses an ultrasonic apparatus that detects multi-feed of sheets using ultrasonic devices. The ultrasonic apparatus includes a pair of ultrasonic devices disposed with a conveyance route of a sheet in between. One ultrasonic device transmits ultrasonic waves, the other ultrasonic device receives the ultrasonic waves transmitted through the sheet. Accordingly, a sheet conveying device for a scanner capable of detecting that a plurality of sheets are simultaneously fed based on the intensity of the reception signal of the ultrasonic waves can be realized.

Further, JP-A-2020-25242 discloses that an ultrasonic device is disposed inside a shield portion having an opening, and a mesh-like protector for suppressing entry of foreign matter is provided in the opening through which ultrasonic waves pass.

JP-A-2020-25242 is an example of the related art.

However, there is room for improvement in the ultrasonic apparatus in JP-A-2020-25242. Specifically, when the mesh is rough, there is a problem in that foreign matter such as paper dust passing through the protector adheres to the surface of the ultrasonic device and the transmission and reception sensitivity of ultrasonic waves becomes lower. If the mesh is made fine, when the foreign matter adhering to the surface of the protector is cleaned with the cleaning liquid, there is a problem that the moisture of the cleaning liquid and the paper dust are mixed and easily fixed to the protector and the transmission and reception sensitivity of the ultrasonic waves becomes lower.

There is a demand for an ultrasonic apparatus in which foreign matter is less likely to adhere to an ultrasonic wave transmission and reception surface and which can transmit ultrasonic waves with high sound pressure or receive ultrasonic waves with high sensitivity.

### SUMMARY

An ultrasonic device according to an application example of the present disclosure includes an ultrasonic element having an ultrasonic wave transmission and reception surface that performs at least one of transmission of ultrasonic waves and reception of ultrasonic waves, and a housing that houses the ultrasonic element, wherein the housing has a reflection surface that reflects the ultrasonic waves, a waveguide that propagates the ultrasonic waves, and an opening provided at one end of the waveguide, through which the ultrasonic waves pass, and a length of the waveguide is longer than a width of the waveguide.

A multi-feed detector according to an application example of the present disclosure includes a transmission ultrasonic device that is the ultrasonic device according to the application example of the present disclosure, the transmission and reception surface transmitting ultrasonic waves, and a reception ultrasonic device that is the ultrasonic device according to the application example of the present disclosure, the transmission and reception surface receiving the ultrasonic waves, wherein the transmission ultrasonic device and the reception ultrasonic device are disposed with a conveyance route of a medium in between, and the ultrasonic waves are transmitted from the transmission ultrasonic device, the ultrasonic waves passing through the medium are received by the reception ultrasonic device, and multi-feed of the media is detected based on intensity of a reception signal.

A conveying device according to an application example of the present disclosure includes the multi-feed detector according to the application example of the present disclosure, and conveys the medium along the conveyance route of the medium.

A scanner according to an application example of the present disclosure includes the conveying device according to the application example of the present disclosure and a reader that reads an image attached to the medium.

### BRIEF DESCRIPTION OF THE DRAWINGS

FIG. 1 is a front perspective view of a scanner according to a first embodiment.

FIG. 2 is a side sectional view showing a document conveyance route of the scanner in FIG. 1.

FIG. 3 is a block configuration diagram showing a control system of the scanner in FIG. 1.

FIG. 4 is a side sectional view showing a configuration of a multi-feed detector.

FIG. 5 is a side sectional view showing a configuration of an ultrasonic device.

FIG. 6 is a perspective view of a main board and the like shown in FIG. 5.

FIG. 7 is a side sectional view of a main part of an ultrasonic element shown in FIG. 6.

FIG. 8 shows a model simulating a waveguide provided in the ultrasonic device in FIG. 5.

FIG. 9 shows a simulation result obtained by three-dimensionally analyzing a sound pressure distribution in a plane intersecting a Pf axis in FIG. 5 when ultrasonic waves are transmitted from the ultrasonic device shown in FIG. 5.

FIG. 10 shows a simulation result obtained by three-dimensionally analyzing a sound pressure distribution in a plane intersecting a Pe axis in FIG. 5 when ultrasonic waves are transmitted from the ultrasonic device shown in FIG. 5.

FIG. 11 shows a simulation result illustrating propagation of ultrasonic waves transmitted from an opening in a free space in the analyses shown in FIGS. 9 and 10.

FIG. 12 shows a simulation result obtained by analyzing a sound pressure distribution regarding an ultrasonic device having a waveguide that does not satisfy Expression (6).

FIG. 13 shows a simulation result obtained by analyzing a sound pressure distribution regarding the ultrasonic device having the waveguide that does not satisfy Expression (6).

FIG. 14 shows a simulation result illustrating propagation of ultrasonic waves transmitted from an opening in a free space in the analyses shown in FIGS. 12 and 13.

FIG. 15 is a side sectional view showing a configuration of an ultrasonic device according to a second embodiment.

FIG. 16 is a side sectional view showing a configuration of an ultrasonic device according to a third embodiment.

FIG. 17 is a side sectional view showing a configuration of an ultrasonic device according to a fourth embodiment.

FIG. 18 is a perspective view of a protector shown in FIG. 17.

### DESCRIPTION OF EMBODIMENTS

Hereinafter, an ultrasonic device, a multi-feed detector, a conveying device, and a scanner according to the present disclosure will be described in detail based on embodiments shown in the accompanying drawings.

### 1. First Embodiment

### 1.1. Outline of Scanner

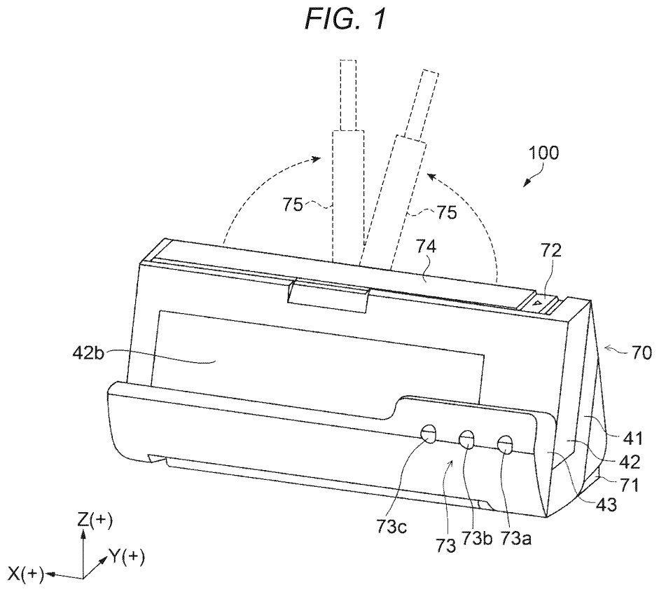

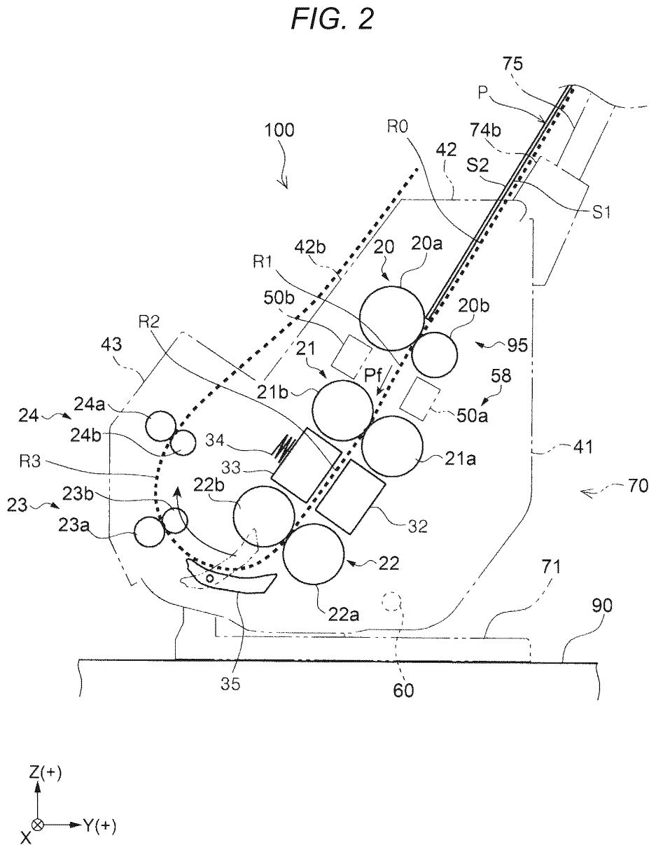

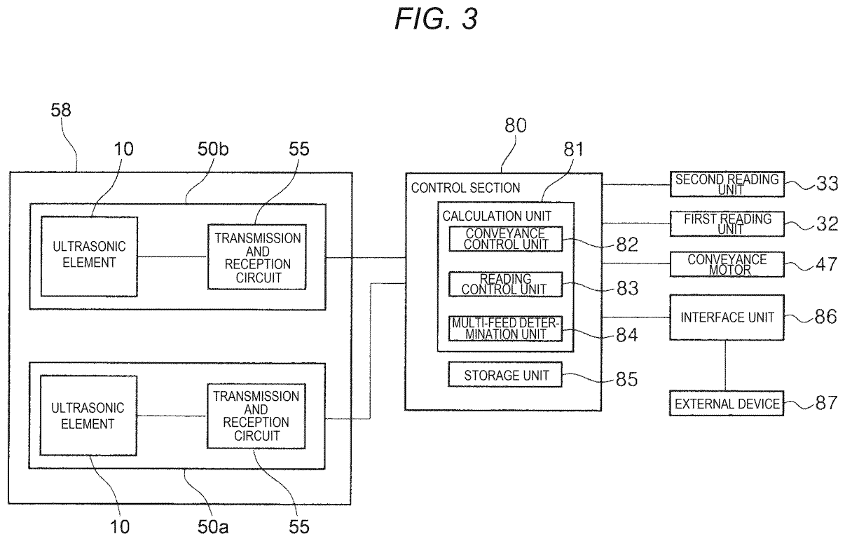

FIG. 1 is a front perspective view of a scanner 100 according to a first embodiment. FIG. 2 is a side sectional view showing a document conveyance route of the scanner 100 in FIG. 1. FIG. 3 is a block configuration diagram showing a control system of the scanner 100 in FIG. 1.

The scanner 100 is a so-called sheet-feed type scanner. The scanner 100 includes a conveying device 95 illustrated in FIG. 2, and a first reader 32 and a second reader 33 illustrated in FIG. 2. The conveying device 95 includes a supply route R0, a conveyance route R1, a reading route R2, and an ejection route R3 illustrated in FIG. 2, and a multi-feed detector 58. The conveying device 95 conveys a document P illustrated in FIG. 2 along a predetermined route. The multi-feed detector 58 detects multi-feed of the documents P passing through the conveyance route R1. The first reader 32 reads a first surface S1 of the document P illustrated in FIG. 2, and the second reader 33 reads a second surface S2 opposite to the first surface S1 of the document P illustrated in FIG. 2.

In the drawings of the present application, an X axis, a Y axis, and a Z axis, which are three axes orthogonal to one another, are indicated by arrows. Directions along the X axis are referred to as “X directions”, directions along the Y axis are referred to as “Y directions”, and directions along the Z axis are referred to as “Z directions”. Further, the pointer side of each arrow is referred to as “plus” and the tail side is referred to as “minus”.

As shown in FIG. 1, the scanner 100 has a laterally long rectangular shape in a front view. In the embodiment, the width direction as the extension direction of the long side of the scanner 100 is the X direction, the depth direction is the Y direction, and the height direction is the Z direction. A direction in which the document P is conveyed is referred to as “downstream”, and a direction opposite to the downstream is referred to as “upstream”. In the drawings below, dimensions and scales different from actual ones may be used for clarity of the description.

As shown in FIG. 1, the scanner 100 includes a main body 70 and a stand 71 that supports the main body 70. The stand 71 is placed on a placement surface 90 shown in FIG. 2. The placement surface 90 is, for example, a horizontal surface such as a top surface of a desk.

As shown in FIGS. 1 and 2, the main body 70 includes a first unit 41, a second unit 42, and a third unit 43. The second unit 42 and the third unit 43 are integrally pivotable about a pivot axis (not illustrated) parallel to the X axis with respect to the first unit 41. Specifically, the second unit 42 and the third unit 43 can be unlocked with respect to the first unit 41 by sliding a lock member 72 illustrated in FIG. 1 in the X minus direction. The lock member 72 is a sliding open/close button that switches between engagement and disengagement of the units.

The second unit 42 and the third unit 43 are pivoted with respect to the first unit 41, and thus a part of the document conveyance route can be exposed. The document conveyance route refers to at least one of the supply route R0, the conveyance route R1, the reading route R2, and the ejection route R3.

In particular, the second unit 42 is opened with respect to the first unit 41, and thus the supply route R0, the conveyance route R1, and the reading route R2 can be exposed. Further, the third unit 43 is pivoted with respect to the second unit 42, and thus the downstream ejection route R3 can be exposed from the reading route R2.

The third unit 43 is engaged with the second unit 42 by a snap-fit structure (not illustrated). When a user applies an external force to the third unit 43, the engagement of the third unit 43 with the second unit 42 is released, and the third unit 43 can be opened.

The main body 70 pivots about a pivot shaft 60 with respect to the stand 71. Accordingly, the main body 70 can take two positions of a normal reading position and a booklet reading position.

The position of the main body 70 illustrated in FIGS. 1 and 2 is the normal reading position. From the normal reading position, the main body 70 is pivoted so that the reading route R2 is closer to being horizontal. In this manner, the position may be shifted to the booklet reading position (not illustrated). As shown in FIG. 1, an operation unit 73 is provided on the front surface of the main body 70. The operation unit 73 is provided with a plurality of operation buttons 73a to 73c. The operation buttons 73a to 73c are assigned with functions of a power button, a read button, and the like, and receive operations by the user.

### 1.2. Document Conveyance Route

Next, the document conveyance route in the scanner 100 will be described with reference to FIG. 2. In FIG. 2, a thick broken line indicates a conveyance route in which the document P is conveyed.

In the document conveyance route, the supply route R0, the conveyance route R1, the reading route R2, and the ejection route R3 are sequentially provided from the upstream side for conveying the document P from document support portions 75 to a front surface 42b of the second unit 42. The front surface 42b is an ejection tray. Examples of the document P include a sheet-like document, a card-like document, and a booklet-like document.

The supply route R0 is the most upstream portion upstream of a first roller pair 20. The conveyance route R1 is a portion between the first roller pair 20 and a second roller pair 21. The reading route R2 is a portion between the second roller pair 21 and a third roller pair 22.

The first unit 41 forms lower parts of the supply route R0, the conveyance route R1, and the reading route R2. The second unit 42 forms upper parts of the supply route R0, the conveyance route R1, and the reading route R2. The ejection route R3 is formed between the second unit 42 and the third unit 43.

In the normal reading position illustrated in FIG. 2, the reading route R2 is coupled to the ejection route R3 by a flap 35. In the booklet reading position, the flap 35 is in a position indicated by a two-dot chain line in FIG. 2, and the reading route R2 is not coupled to the ejection route R3. In this case, the document P is ejected from the reading route R2 in an obliquely downward direction (Y minus direction) in front of the main body 70.

The normal reading position is suitable for reading an image attached to a sheet-like document or the like, that is, the document P having lower rigidity and being easily bent. The booklet reading position is suitable for reading a document P having higher rigidity and being hardly bent such as a plastic card or a booklet.

As illustrated in FIG. 2, the document P before reading is supported in an inclined position by a support portion 74b and the document support portions 75. The support portion 74b is a portion of an upper cover 74 in FIG. 1 being pivoted and stood. The upper cover 74 pivots around a pivot (not illustrated) to open and close a feeding port of the document P.

As shown in FIG. 1, the document support portions 75 are housed in the upper cover 74 in the housed state with the upper cover 74 closed. When the upper cover 74 is opened, as indicated by dotted lines in FIG. 1, the two document support portions 75 pivot and stand on the upper part of the main body 70, and can support the document P. In the scanner 100, a so-called center feeding method is adopted, and the center position of the document P in the X direction (width direction) is the same regardless of the size of the document P. The upper cover 74 and the document support portions 75 are component portions of the first unit 41.

In FIG. 2, when a plurality of documents P are set on the document support portions 75, the uppermost document P is fed downstream by a roller 20a of the first roller pair 20. The first roller pair 20 includes the roller 20a as a driving roller and a roller 20b as a driven roller.

The roller 20a is provided in the second unit 42. The roller 20a is the driving roller that rotates by power from a conveyance motor 47 shown in FIG. 3.

The roller 20b is provided in the first unit 41. The roller 20b faces the roller 20a via the supply route R0. A torque limiter (not illustrated) is attached to the roller 20b. Accordingly, multi-feed of the documents P is suppressed.

As illustrated in FIG. 2, a conveyance direction of the document P in the conveyance route R1 is denoted by Pf. The configuration of the scanner is not limited to the configuration in which the documents are fed from the uppermost document P, and may be a configuration in which the lower roller 20b is a driving roller, the roller 20a is a driven roller, and the documents are fed from the lowermost document P.

The multi-feed detector 58 is provided in the conveyance route R1. The multi-feed detector 58 includes an ultrasonic device 50a and an ultrasonic device 50b disposed to face each other with the conveyance route R1 in between. The multi-feed detector 58 detects multi-feed of the documents P passing through the conveyance route R1. Specifically, the ultrasonic device 50a transmits ultrasonic waves and the ultrasonic device 50b receives the ultrasonic waves. In other words, the multi-feed detector 58 includes a pair of the transmission ultrasonic device 50a and the reception ultrasonic device 50b, and the ultrasonic device 50a and the ultrasonic device 50b are disposed with the conveyance route R1 (conveyance path) of the sheet-like document P (medium) in between. Further, the ultrasonic device 50a transmits ultrasonic waves, the ultrasonic device 50b receives the ultrasonic waves passing through the document P, and multi-feed of the documents P is detected based on the intensity of the received signal.

The second roller pair 21 is provided downstream of the first roller pair 20.

The second roller pair 21 includes a roller 21a provided in the first unit 41 and a roller 21b provided in the second unit 42. The roller 21b is provided so as to be movable toward and away from the roller 21a. The roller 21b is pressed toward the roller 21a by a pressing member (not illustrated) such as a coil spring. Accordingly, the roller 21b moves toward and away from the roller 21a according to the thickness of the conveyed document P. Both the roller 21a and the roller 21b rotate by power from the conveyance motor 47.

When the second unit 42 is closed with respect to the first unit 41, the roller 21a and the roller 21b come into contact with each other. When the second unit 42 is opened with respect to the first unit 41, the roller 21a and the roller 21b are separated from each other.

The first reader 32 and the second reader 33 are disposed to face each other downstream of the second roller pair 21. The first reader 32 is provided in the first unit 41, and the second reader 33 is provided in the second unit 42.

The first reader 32 reads the first surface S1 of the document P, and the second reader 33 reads the second surface S2 opposite to the first surface S1 of the document P. The second reader 33 is provided to be movable toward and away from the first reader 32, and is pressed toward the first reader 32 by a pressing spring 34 (pressing member). Accordingly, the second reader 33 moves toward and away from the first reader 32 according to the thickness of the conveyed document P. Examples of the first reader 32 and the second reader 33 include a contact image sensor module (CISM).

The third roller pair 22 is provided downstream of the first reader 32 and the second reader 33. The third roller pair 22 includes a roller 22a provided in the first unit 41 and a roller 22b provided in the second unit 42. The roller 22b is provided so as to be movable toward and away from the roller 22a. The roller 22b is pressed toward the roller 22a by a pressing member (not illustrated) such as a coil spring. Accordingly, both the roller 22a and the roller 22b rotate by power from the conveyance motor 47.

When the second unit 42 is closed with respect to the first unit 41, the roller 22a and the roller 22b come into contact with each other. When the second unit 42 is opened with respect to the first unit 41, the roller 22b is separated from the roller 22a. When the second unit 42 is opened, the first reader 32 and the second reader 33 are exposed, and thus cleaning can be performed. At the same time, the ultrasonic device 50a and the ultrasonic device 50b are also exposed together, cleaning can be performed together. It is preferable to remove the foreign matter by air blowing when the contamination is minor, and to perform cleaning with a cleaning liquid when the contamination is fixed.

The flap 35 is provided downstream of the third roller pair 22. The flap 35 pivots to switch between the above-described two document conveyance routes. The flap 35 pivots in conjunction with the switching of the position of the main body 70. Examples of the configuration for rotating the flap 35 in conjunction with the switching of the position of the main body 70 include a configuration of mechanically rotating the flap in conjunction with the position of the main body 70 by an interlocking mechanism (not illustrated) such as a cam mechanism. The flap 35 is not limited to the configuration, and may have a configuration to be rotated by a solenoid (not illustrated).

The ejection route R3 is also referred to as a U-turn route because the document P conveyed in the Z minus direction is caused to make a U-turn along the flap 35 and ejected in the Z plus direction.

A fourth roller pair 23 and a fifth roller pair 24 are provided in the ejection route R3. The fourth roller pair 23 includes a roller 23a provided in the third unit 43 and a roller 23b provided in the second unit 42. The roller 23b is provided so as to be movable toward and away from the roller 23a. The roller 23b is pressed toward the roller 23a by a pressing member (not illustrated) such as a coil spring. Accordingly, the roller 23b moves toward and away from the roller 23a according to the thickness of the conveyed document P. The roller 23a is a driving roller driven by the conveyance motor 47. The roller 23b is a driven roller.

The fifth roller pair 24 includes a roller 24a provided in the third unit 43 and a roller 24b provided in the second unit 42. The roller 24b is provided so as to be movable toward and away from the roller 24a. The roller 24b is pressed toward the roller 24a by a pressing member (not illustrated) such as a coil spring. Accordingly, the roller 24b moves toward and away from the roller 24a according to the thickness of the conveyed document P. The roller 24a is a driving roller driven by the conveyance motor 47. The roller 24b is a driven roller.

When the third unit 43 is closed with respect to the second unit 42, the roller 23a and the roller 23b come into contact with each other. Similarly, the roller 24a and the roller 24b come into contact with each other.

When the third unit 43 is opened with respect to the second unit 42, the roller 23a and the roller 23b are separated from each other. Similarly, the roller 24a and the roller 24b are separated from each other.

The document P passing through the ejection route R3 is ejected in the Z plus direction by the fifth roller pair 24, and is supported in an inclined position by the front surface 42b of the second unit 42.

### 1.3. Control System

Next, a control system of the scanner 100 shown in FIG. 3 will be described.

A control section 80 includes a calculation unit 81 including one or more processors, and a storage unit 85 including a nonvolatile memory or a volatile memory.

The first reader 32, the second reader 33, the conveyance motor 47, and the multi-feed detector 58 are coupled to the control section 80, and the control section 80 performs integrated control thereof.

The conveyance motor 47 is a drive source for the roller 20a, the rollers 21a and 21b, the rollers 22a and 22b, the roller 23a, and the roller 24a. Although individual drive motors may be provided for the respective rollers, the drive motors are illustrated as the same functional block in FIG. 3.

As illustrated in FIG. 3, the scanner 100 includes an interface unit 86 that couples an external device 87 and the control section 80.

The control section 80 receives various data and signals input from the external device 87 such as a personal computer via the interface unit 86. The control section 80 outputs the read data read by the scanner 100 to the external device 87.

Various data and various programs for controlling the scanner 100 are recorded in the storage unit 85.

The calculation unit 81 reads and executes various programs stored in the storage unit 85 to implement the functions of the conveyance control unit 82, the reading control unit 83, and the multi-feed determination unit 84.

The conveyance control unit 82 controls the conveyance motor 47 to rotate the above-described plurality of rollers, thereby feeding, conveying, and ejecting the document P.

The reading control unit 83 controls the first reader 32 and the second reader 33 during the conveyance of the document P to read the image of the document P.

The multi-feed determination unit 84 detects the state of the document P and determines multi-feed of the document P based on the reception signal output from the multi-feed detector 58.

As described above, the multi-feed detector 58 includes the ultrasonic device 50a that transmits ultrasonic waves and the ultrasonic device 50b that receives ultrasonic waves. The ultrasonic device 50a includes an ultrasonic element 10 and a transmission and reception circuit 55. The ultrasonic device 50b includes an ultrasonic element 10 and a transmission and reception circuit 55. Each transmission and reception circuit 55 can switch between a transmission circuit and a reception circuit of ultrasonic waves. That is, the transmission and reception circuit 55 provided in the ultrasonic device 50a functions as a transmission circuit that transmits ultrasonic waves, and causes the ultrasonic element 10 to transmit ultrasonic waves having a frequency corresponding to the drive signal. The transmission and reception circuit 55 functions as a reception circuit that receives ultrasonic waves in the ultrasonic device 50b, and detects a signal level of the ultrasonic waves entering the ultrasonic element 10. Note that a dedicated transmission circuit or reception circuit may be provided. When the voltage value of the reception signal of the ultrasonic device 50b is smaller than a predetermined threshold value, the multi-feed determination unit 84 determines that the documents P are multi-fed. When the multi-feed determination unit 84 determines that multi-feed occurs, the conveyance control unit 82 stops conveyance of the documents P.

### 1.4. Multi-Feed Detector

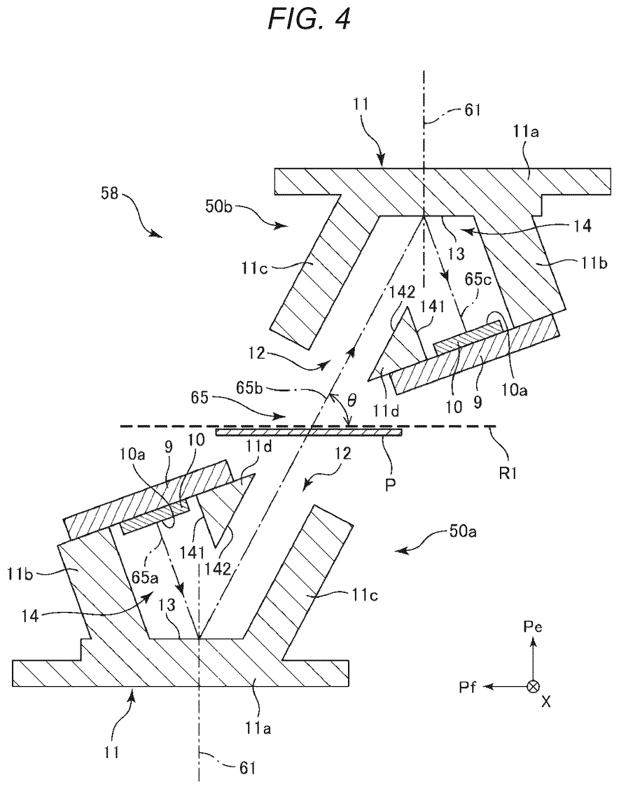

FIG. 4 is a side sectional view showing a configuration of the multi-feed detector 58. FIG. 4 illustrates side cross sections of main parts of the ultrasonic device 50a and the ultrasonic device 50b facing each other via the conveyance route R1. In FIG. 4, the X axis, the conveyance direction Pf of the document P, and a perpendicular direction Pe orthogonal to the conveyance direction Pf are coordinate axes as three axes orthogonal to each other.

Each of the ultrasonic device 50a and the ultrasonic device 50b shown in FIG. 4 includes a housing 11.

The ultrasonic waves emitted from the ultrasonic element 10 of the ultrasonic device 50a (transmission ultrasonic device) propagate through a waveguide 14, are reflected by a reflection surface 13 of the housing 11, and then are emitted from an opening 12 through the waveguide 14 again. Thereafter, the emitted ultrasonic waves pass through the conveyance route R1 and enter the ultrasonic device 50b (reception ultrasonic device). In the present embodiment, the ultrasonic device 50a and the ultrasonic device 50b have the same configuration. Therefore, the ultrasonic waves passing through the conveyance route R1 enter from the opening 12 of the ultrasonic device 50b, pass through the waveguide 14, are reflected by the reflection surface 13, pass through the waveguide 14 again, and enter the ultrasonic element 10 of the ultrasonic device 50b.

In FIG. 4, a propagation route of an ultrasonic beam emitted from the ultrasonic element 10 of the ultrasonic device 50a is illustrated as a central axis 65. That is, the ultrasonic waves propagate along the central axis 65. Specifically, the ultrasonic waves are emitted from the ultrasonic element 10 of the ultrasonic device 50a around a central axis 65a, then reflected by the reflection surface 13, travel around a central axis 65b, are reflected by the reflection surface 13 at the reception side, travel around a central axis 65c, and enter the ultrasonic element 10 of the ultrasonic device 50b. The central axes 65a to 65c are collectively referred to as the central axis 65.

The central axis 65b (a perpendicular line of the opening 12) may be orthogonal to the conveyance route R1, but is inclined at an angle θ in FIG. 4. That is, it is preferable that the central axis 65b is not orthogonal to the document P irradiated with the ultrasonic waves, but is inclined. As described above, by inclining the central axis 65b with respect to the conveyance route R1, multiple reflection of ultrasonic waves between the document P and the ultrasonic device 50a can be suppressed. Specifically, when the central axis 65b is aligned with the perpendicular direction of the document P, that is, when the angle θ of the central axis 65b with respect to the document P is 90°, the ultrasonic waves emitted from the ultrasonic element 10 may be multiply reflected between the document P and the ultrasonic element 10.

The angle θ is preferably from 50° to less than 90°, and more preferably from 60° to 80°.

### 1.5. Ultrasonic Device

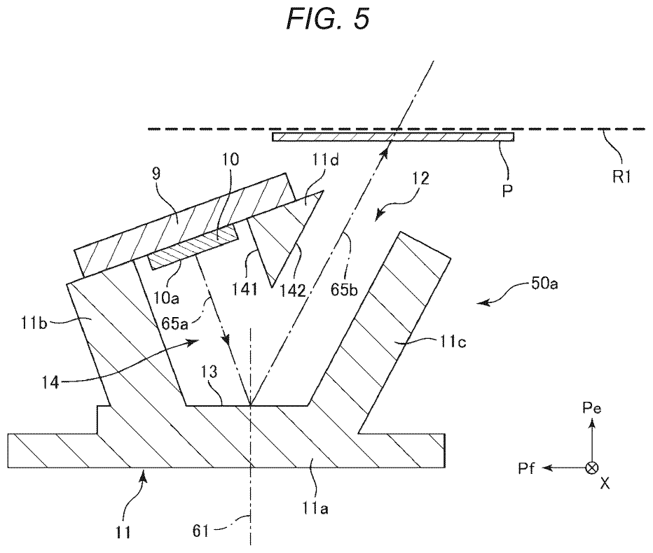

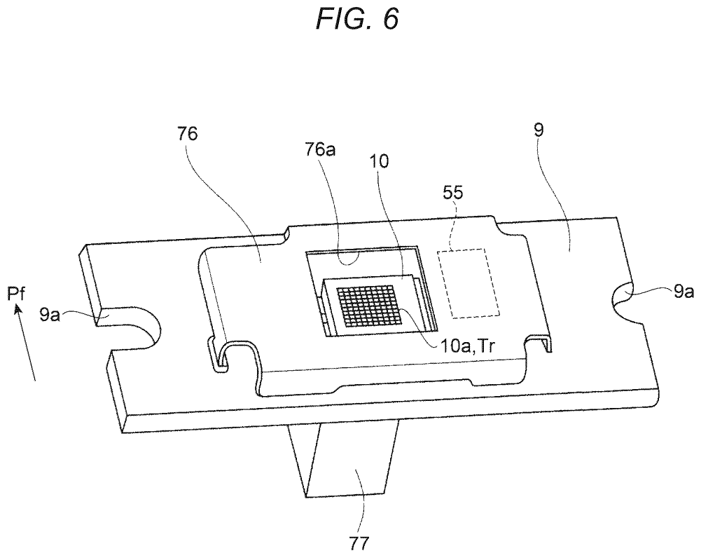

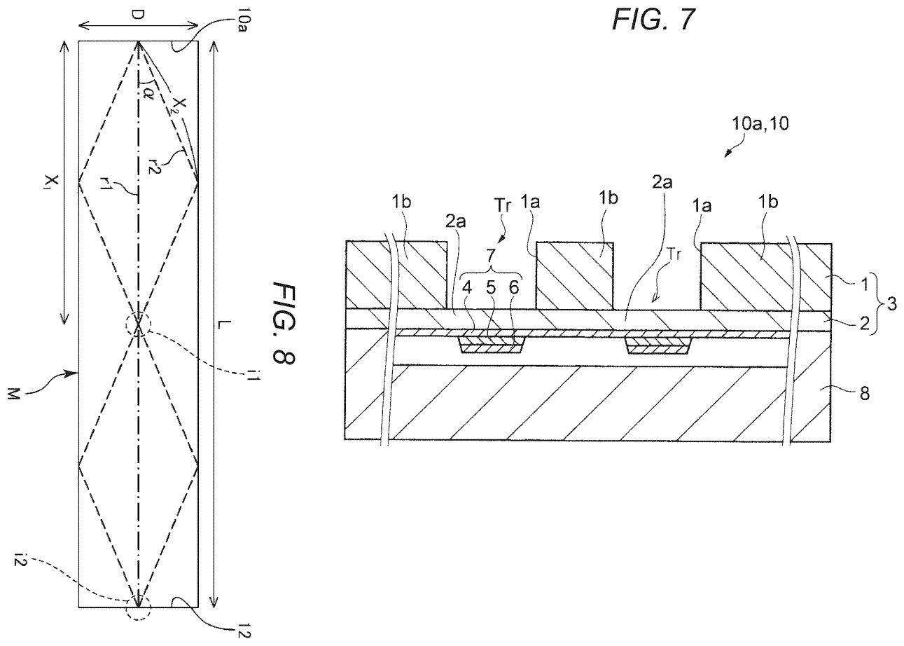

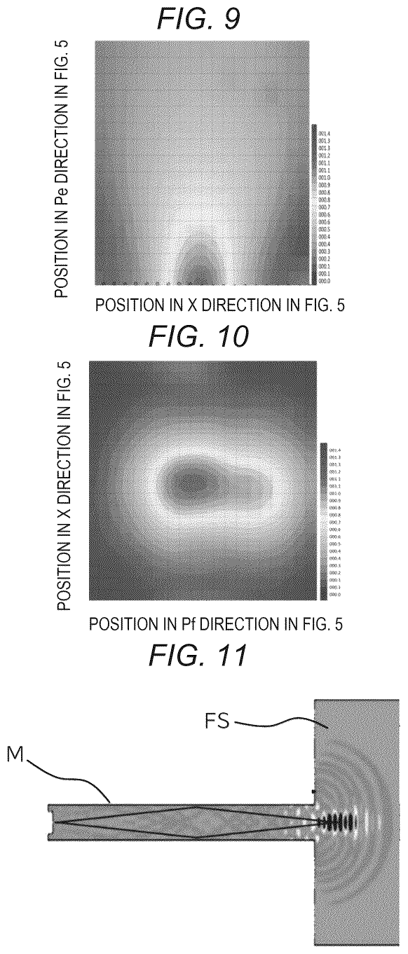

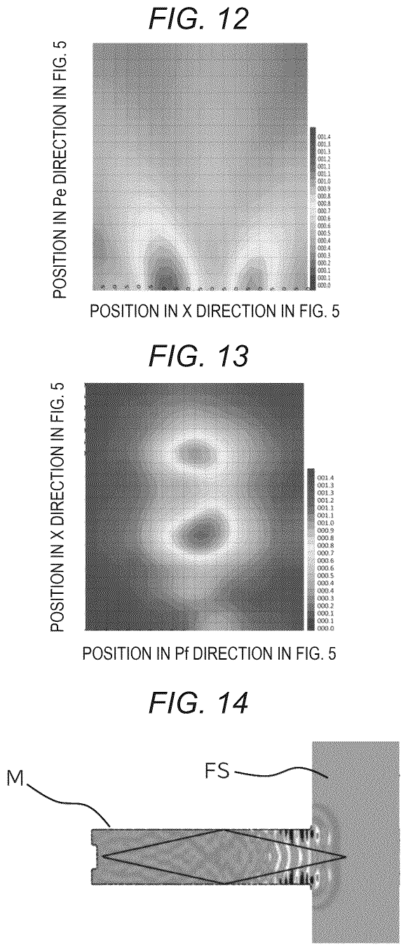

FIG. 5 is a side sectional view showing a configuration of the ultrasonic device 50a. FIG. 6 is a perspective view of a main board 9 and the like shown in FIG. 5. FIG. 7 is a side sectional view of a main part of the ultrasonic element 10 shown in FIG. 6. Here, the configuration of the ultrasonic device 50a shown in FIG. 5 will be described as a representative, but the configuration of the ultrasonic device 50b shown in FIG. 4 is the same as that of the ultrasonic device 50a, and only the placement position is different. It is not essential that the configuration of the ultrasonic device 50b is the same as the configuration of the ultrasonic device 50a, and both may be different from each other.

The ultrasonic device 50a shown in FIG. 5 includes the main board 9 in addition to the ultrasonic element 10 and the housing 11 described above.

The housing 11 is a case that houses the ultrasonic element 10. As illustrated in FIG. 5, the housing 11 includes a base portion 11a as a plate-shaped portion substantially parallel to the conveyance route R1, a first wall 11b extending from the base portion 11a along the central axis 65a, a second wall 11c extending from the base portion 11a along the central axis 65b, and a third wall 11d facing the second wall 11c. The first wall 11b and the second wall 11c are provided so as to open in a V-shape from the base portion 11a.

The inner surface of the base portion 11a is the flat reflection surface 13.

The inner surfaces of the first wall 11b and the third wall 11d forms a waveguide 14 that propagates ultrasonic waves emitted from the ultrasonic element 10 to the reflection surface 13. The central axis 65a passes through the center of the waveguide 14. The surface of the ultrasonic element 10 is referred to as a transmission and reception surface 10a. The central axis 65a is a perpendicular line of the transmission and reception surface 10a.

The opening 12 is formed at the ends of the second wall 11c and the third wall 11d. That is, the opening 12 is provided at one end of the waveguide 14 for passing the ultrasonic waves propagated by the waveguide 14 and emitting the ultrasonic waves to the free space. The opening 12 has a rectangular shape in a plan view from the conveyance route R1 side. The inner surfaces of the second wall 11c and the third wall 11d form a waveguide 14 that propagates the ultrasonic waves reflected by the reflection surface 13 to the opening 12. The central axis 65b passes through the center of the waveguide 14. The central axis 65b is the perpendicular line of the opening 12.

Therefore, in the ultrasonic device 50a shown in FIG. 5, the waveguide 14 is configured with two portions coupled via the reflection surface 13 provided in the middle thereof. A portion extending from the ultrasonic element 10 to the reflection surface 13 (a portion extending along the central axis 65a) is referred to as “first portion 141”, and a portion extending from the reflection surface 13 to the opening 12 (a portion extending along the central axis 65b) is referred to as “second portion 142”.

According to the configuration, the ultrasonic waves emitted from the ultrasonic element 10 shown in FIG. 5 can be reflected by the reflection surface 13 and emitted from the opening 12. That is, the ultrasonic element 10 is not directly viewed from the opening 12. Therefore, even when foreign matter enters the waveguide 14 from the opening 12, the probability of the foreign matter adhering to the transmission and reception surface 10a of the ultrasonic element 10 can be reduced.

Examples of the constituent material of the housing 11 include metal and resin. When the housing 11 is formed using metal, a shielding effect of protecting the ultrasonic element 10 from the influence of static electricity or electromagnetic waves is obtained. When the housing 11 is formed using resin, the housing 11 can be efficiently formed by injection molding. For example, in the housing 11 illustrated in FIG. 5, when a portion including the base portion 11a and a portion including the first wall 11b, the second wall 11c, and the third wall 11d are injection molded parts, molding efficiency is increased.

The main board 9 is attached between the end of the first wall 11b and the end of the third wall 11d. The ultrasonic element 10 is mounted on the main board 9.

As shown in FIG. 6, the main board 9 is a rectangular board. Both short sides of the main board 9 are provided with cutout holes 9a for fastening by screws.

The ultrasonic element 10, the transmission and reception circuit 55, a cover member 76, and the like are mounted on the surface of the main board 9. The ultrasonic element 10 is a component having a rectangular shape in the plan view.

As illustrated in FIG. 7, the ultrasonic element 10 includes a base substrate 8, an element substrate 3 stacked thereon, and vibrating portions 7. The base substrate 8 is a mounting substrate and includes a plurality of terminals (not illustrated) on a lower surface thereof. The element substrate 3 includes a semiconductor substrate 1 and a diaphragm 2.

The semiconductor substrate 1 includes, for example, a silicon substrate. The semiconductor substrate 1 is provided with openings 1a as a plurality of through holes in a grid pattern. The openings 1a are defined by partition walls 1b.

The diaphragm 2 is formed of, for example, a stacked structure in which a plurality of SiO₂ films are stacked. The configuration of the diaphragm 2 is not limited thereto, and may be a stacked structure in which a plurality of SiO₂ films and a plurality of ZrO₂ films are alternately stacked. The diaphragm 2 is provided on the surface of the semiconductor substrate 1 at the base substrate 8 side to close the plurality of openings 1a.

The vibrating portion 7 is provided in a portion 2a of the diaphragm 2 overlapping the opening 1a. The vibrating portion 7 illustrated in FIG. 7 includes a first electrode 4, a piezoelectric element 5, and a second electrode 6 stacked on the diaphragm 2. The first electrode 4 is a solid electrode and is provided to cover all the openings 1a and the partition walls 1b. The piezoelectric elements 5 are selectively provided in the portions 2a overlapping the openings 1a. Examples of the constituent material of the piezoelectric element 5 include, but are not limited to, lead zirconate titanate (PZT). The second electrodes 6 are provided, for example, in a stripe shape along the extension direction of the short side of the main board 9. A space is provided between the vibrating portion 7 and the base substrate 8 so as not to hinder the vibration of the vibrating portion 7.

As shown in FIG. 7, the vibrating portion 7 provided to correspond to the opening 1a forms one ultrasonic transducer Tr. As shown in FIG. 6, a plurality of the ultrasonic transducers Tr are provided in a matrix on the transmission and reception surface 10a of the ultrasonic element 10. The ultrasonic transducers Tr are electrically coupled to the transmission and reception circuit 55.

The metal cover member 76 that covers the ultrasonic element 10 and the transmission and reception circuit 55 is provided on the surface of the main board 9 as shown in FIG. 6. The cover member 76 is provided with an opening 76a that exposes the transmission and reception surface 10a of the ultrasonic element 10. A power supply potential such as GND is supplied to the cover member 76 to protect the ultrasonic element 10 and the transmission and reception circuit 55 from static electricity and electromagnetic waves. The cover member 76 is not essential, and may be omitted when the housing 11 is made of metal and has a shielding property.

A connector 77 is mounted on the back surface of the main board 9. A cable (not illustrated) is coupled to the connector 77. Accordingly, the ultrasonic device 50a is electrically coupled to the control section 80 illustrated in FIG. 3.

FIG. 5 shows a cross section in the short-side direction of the main board 9. The main board 9 is fastened by screws to the housing 11 using the two cutout holes 9a shown in FIG. 6 provided at the front and back sides in the depth direction (X direction).

FIG. 8 shows a model M simulating the waveguide 14 provided in the ultrasonic device 50a in FIG. 5.

The model M shown in FIG. 8 is obtained by linearly extending and simplifying the waveguide 14 shown in FIG. 5 into a rectangle having a length L and a width D. One short side of the model M is the transmission and reception surface 10a, and the other short side is the opening 12. Therefore, the length L is the sum of the length of the central axis 65a from the transmission and reception surface 10a of the ultrasonic element 10 to the reflection surface 13 and the length of the central axis 65b from the reflection surface 13 to the opening 12. The width D represents each of a length in a direction orthogonal to the central axes 65a and 65b in the cross section shown in FIG. 5 and a length in a direction orthogonal to the cross section shown in FIG. 5.

In the ultrasonic device 50a according to the present embodiment, the waveguide 14 is configured such that the length L is longer than the width D. That is, D<L is satisfied in the model M. The ultrasonic waves emitted from one short side of the model M are divided into a component propagating substantially parallel along the long side and a component reflected by the inner surface of the model M. These components strengthen or weaken each other due to interference, but when D<L is satisfied, the probability that the components strengthen each other in the vicinity of the opening 12 is higher than that when L≤D is satisfied. As a result, the ultrasonic device 50a that can transmit ultrasonic waves with high sound pressure in the vicinity of the opening 12 can be realized. Further, the ultrasonic device 50b that can receive ultrasonic waves with high sensitivity can be realized.

Therefore, the housing 11 has the opening 12, the reflection surface 13, and the waveguide 14, and the length L and the width D of the waveguide 14 satisfy the above-described relationship, and thus the ultrasonic device 50a in which foreign matter is unlikely to adhere to the transmission and reception surface 10a of the ultrasonic element 10 and which can transmit ultrasonic waves with high sound pressure, or the ultrasonic device 50b in which foreign matter is unlikely to adhere to the transmission and reception surface 10a of the ultrasonic element 10 and which can receive ultrasonic waves with high sensitivity can be realized.

The ultrasonic devices 50a and 50b are provided, and thus the multi-feed detector 58 with high determination accuracy of multi-feed in which maintenance of the ultrasonic devices 50a and 50b is easy can be realized.

The multi-feed detector 58 is provided, and thus the conveying device 95 having excellent maintainability and high determination accuracy of multi-feed can be realized.

The conveying device 95 is provided, and thus the scanner 100 having excellent maintainability, high determination accuracy of multi-feed, and excellent handleability can be realized.

The length of the first portion 141 in the extension direction of the central axis 65a (the perpendicular line of the transmission and reception surface 10a) is preferably longer than the width of the first portion 141. Further, the length of the second portion 142 in the extension direction of the central axis 65b (the perpendicular line of the opening 12) is preferably longer than the width of the second portion 142.

According to the configuration, attenuation of the ultrasonic waves is easily suppressed in both the first portion 141 and the second portion 142. Therefore, the ultrasonic device 50a that can transmit ultrasonic waves with higher sound pressure or the ultrasonic device 50b that can receive ultrasonic waves with higher sensitivity can be realized.

The length L of the model M is preferably optimized based on a wavelength λ and a propagation angle α of the ultrasonic waves emitted from the ultrasonic element 10. This further increases the probability that the ultrasonic waves strengthen each other in the vicinity of the opening 12. Such an effect can be described using the following calculation expressions.

A solid line drawn inside the model M in FIG. 8 represents a propagation route r1 of a component propagating substantially parallel along the long side of the ultrasonic waves emitted from one short side of the model M. A broken line drawn in FIG. 8 represents a propagation route r2 of a component reflected by the inner surface of the model M. In the model M illustrated in FIG. 8, as an example, the propagation routes r1 and r2 intersect at the intermediate point of the length L and the opening 12. That is, interference occurs at these two locations. Hereinafter, these two locations are referred to as interference points i1 and i2. In design of the waveguide 14, it is required to optimize the length L and the width D so that the two components cause a strengthening interference with each other in the opening 12. Hereinafter, the example of the calculation expressions will be described.

In the model M of FIG. 8, the propagation route r2 intersects the propagation route r1 at a propagation angle α. The distance from the transmission and reception surface 10a to the interference point i1 (the midpoint of the length L) is denoted by X₁, and the distance from the transmission and reception surface 10a to the point at which the propagation route r2 is first reflected by the inner wall surface of the model M is denoted by X₂. In this case, a path difference Δp between the distance X₁ and the distance X₂ is expressed by the following Expression (1).

$$\begin{matrix}Δ p & = 2 {X}_{2} - {X}_{1} \\ & = \sqrt{{X}_{1}^{2} + {D}^{2}} - {X}_{1} \\ & = {X}_{1} ( \sqrt{1 + {( \frac{D}{{X}_{1}} )}^{2}} - 1 ) \\ & = {X}_{1} ( \sqrt{1 + {tan}^{2} α} - 1 ) \\ & = {X}_{1} ( \frac{1}{cos α} - 1 )\end{matrix} \qquad ( 1 )$$

When the path difference Δp is an integral multiple of the wavelength λ of the ultrasonic waves, a strengthening interference occurs at the interference point i1. In this case, the path difference Δp is expressed by the following Expression (2) using the wavelength λ.

$$Δ p = n λ \qquad ( 2 )$$

In the above Expression (2), n is an integer.

Then, the following Expression (3) is derived from the above Expressions (1) and (2).

$${X}_{1} ( \frac{1}{cos α} - 1 ) = n λ \qquad ( 3 )$$

The above Expression (3) is transformed, thereby deriving the following Expression (4).

$$\begin{matrix}{X}_{1} & = n λ / ( \frac{1}{cos α} - 1 ) \\ & = \frac{cos α}{1 - cos α}\end{matrix} \qquad ( 4 )$$

In the above Expression (4), the distance X₁ is represented by the wavelength λ.

Then, in order to expand the distance X₁ to the length L which is the entire length of the model M, the distance X₁ in the above Expression (4) is replaced with the length L. That is, it is considered that only the interference point i2 is present in the model M (the interference point i1 is not present). Then, a condition under which a strengthening interference occurs in the opening 12 is expressed by the following Expression (5).

$$L = \frac{cos α}{1 - cos α} k λ \qquad ( 5 )$$

In the above Expression (5), k is an integer.

Therefore, in the design of the waveguide 14, the length L and the width D may be set to satisfy the above Expression (5).

Note that the above Expression (5) is the most ideal design value. In the design of the waveguide 14, the following Expression (6) is preferably satisfied.

$$0.9 \times \frac{cos α}{1 - cos α} k λ ≦ L ≦ 1.1 \times \frac{cos α}{1 - cos α} k λ \qquad ( 6 )$$

In the above Expression (6), k is an integer.

By designing the waveguide 14 so as to satisfy the above Expression (6), the probability of occurrence of a strengthening interference in the opening 12 can be particularly increased. Accordingly, the ultrasonic device 50a that can transmit ultrasonic waves with higher sound pressure or the ultrasonic device 50b that can receive ultrasonic waves with higher sensitivity can be realized. The multi-feed detector 58 having high determination accuracy of multi-feed can be realized.

The integer k in the above Expression (6) is not particularly limited, but is preferably set to a value such that the width D of the waveguide 14 is one fifth or less of the length L of the waveguide 14. Accordingly, the propagation angle α falls within an appropriate range, and thus the ultrasonic device 50a that can transmit ultrasonic waves with high sound pressure in the vicinity of the opening 12 or the ultrasonic device 50b that can receive ultrasonic waves with high sensitivity can be realized.

As an example, the length L is preferably from about 15 mm to 40 mm, and more preferably from about 18 mm to 30 mm.

As an example, the width D is preferably from about 1 mm to 10 mm, and more preferably from about 2 mm to 5 mm.

As described above, the width D represents each of the length in the direction orthogonal to the central axes 65a and 65b in the cross section shown in FIG. 5 and the length in the direction orthogonal to the cross section shown in FIG. 5, but these lengths may be the same as or different from each other.

Further, in the model M shown in FIG. 8, when the interference points i1 and i2 are present, it is desirable to optimize the positional relationship between the interference point i1 and the reflection surface 13.

Specifically, the interference point i1 is preferably located between the ultrasonic element 10 and the reflection surface 13, and more preferably located immediately before the reflection surface 13. Accordingly, the component propagating through the propagation route r1 and the component propagating through the propagation route r2 can be focused to be thinner and incident on the reflection surface 13. As a result, variations in reflection angle of the ultrasonic waves on the reflection surface 13 can be suppressed. Note that “immediately before the reflection surface 13” refers to, for example, a range within one fourth of the length of the central axis 65a from the reflection surface 13.

Further, in the model M shown in FIG. 8, the near field length is not considered and simplified, but this may be considered. The near field length refers to, when the ultrasonic waves generated from the ultrasonic element 10 are disturbed in near field, a length affected by the disturbance. When the size of the transmission and reception surface 10a of the ultrasonic element 10 is d, a near field length X₀ is obtained by X₀=d²/(4λ). Therefore, when the design value of the length L of the waveguide 14 is obtained, a value obtained by adding the near field length X₀ to the value calculated by the above Expressions (1) to (6) may be adopted.

Further, the position of the interference point i2 may be designed to be shifted outward from the opening 12. When a shift amount in this case is F₀, the shift amount F₀ is obtained by calculation or experiment. For example, the shift amount F₀ may be calculated based on an approximate expression F₀=0.0162×D^{3.8076} obtained from an experiment. In this case, for the design value of the length L of the waveguide 14, a value obtained by subtracting the shift amount F₀ from the value calculated by the above Expressions (1) to (6) may be adopted.

As shown in FIG. 5, the reflection surface 13 is provided on the central axis 65a and the central axis 65b. The central axis 65a and the central axis 65b are inclined with respect to a normal line 61 of the reflection surface 13. In other words, the normal line 61 of the reflection surface 13 is inclined with respect to both the central axis 65a (the perpendicular line of the transmission and reception surface 10a) and the central axis 65b (the perpendicular line of the opening 12).

According to the configuration, the probability that the ultrasonic waves emitted from the ultrasonic element 10 shown in FIG. 5 are reflected by the reflection surface 13 and emitted from the opening 12 can be increased. Further, the probability that the ultrasonic waves reflected by the reflection surface 13 return to the ultrasonic element 10 can be reduced. Accordingly, the sound pressure of the ultrasonic waves emitted from the opening 12 can be sufficiently increased.

By changing the propagation direction of the ultrasonic waves via the reflection surface 13, the ultrasonic element 10 can be housed inside the housing 11. Accordingly, even when foreign matter such as paper dust enters the inside of the housing 11 from the opening 12, the foreign matter remains on the reflection surface 13, and thus the probability that the foreign matter adheres to the transmission and reception surface 10a of the ultrasonic element 10 can be reduced. As a result, attenuation of the ultrasonic waves emitted from the ultrasonic element 10 due to the foreign matter can be suppressed. The foreign matter remaining on the reflection surface 13 can be easily cleaned by, for example, air blowing, as will be described later.

In addition, in the ultrasonic device 50b, the reception sensitivity of the ultrasonic waves incident from the opening 12 can be increased, the probability that the foreign matter adheres to the ultrasonic element 10 can be reduced, and the foreign matter can be easily removed.

The central axis 65a and the central axis 65b shown in FIG. 5 are inclined in opposite directions with respect to the normal line 61 of the reflection surface 13.

According to the configuration, the ultrasonic waves emitted from the ultrasonic element 10 shown in FIG. 5 and reflected by the reflection surface 13 can be emitted from the opening 12 with suppressed attenuation. As a result, the ultrasonic device 50a that can transmit ultrasonic waves with high sound pressure can be realized.

In this case, the angle formed by the normal line 61 and the central axis 65a (the incident angle of the ultrasonic waves with respect to the reflection surface 13) is preferably equal to the angle formed by the normal line 61 and the central axis 65b (the reflection angle of the ultrasonic waves with respect to the reflection surface 13). Accordingly, the reflection efficiency of the ultrasonic waves on the reflection surface 13 can be increased, and the ultrasonic waves with high sound pressure can be transmitted from the opening 12.

In the present specification, “equal angles” means that a difference between two angles is 5° or less. Further, the two angles are not necessarily equal to each other, and may be different from each other.

The central axis 65a (the perpendicular line of the transmission and reception surface 10a) and the central axis 65b (the perpendicular line of the opening 12) illustrated in FIG. 5 intersect each other on the reflection surface 13.

According to the configuration, when the ultrasonic waves propagating along the central axis 65a are reflected by the reflection surface 13, the reflection efficiency can be sufficiently increased. As a result, the ultrasonic device 50a that can transmit ultrasonic waves with high sound pressure from the opening 12 can be realized. Further, the ultrasonic device 50b that can receive ultrasonic waves with high sensitivity can be realized.

FIG. 9 shows a simulation result obtained by three-dimensionally analyzing a sound pressure distribution in a plane intersecting the Pf axis in FIG. 5 when ultrasonic waves are transmitted from the ultrasonic device 50a shown in FIG. 5. The horizontal axis of FIG. 9 indicates a position in the X direction in FIG. 5, and the vertical axis of FIG. 9 indicates a position in the Pe direction in FIG. 5. The sound pressure distribution in FIG. 9 is a distribution at a position 10 mm apart from the opening 12 illustrated in FIG. 5 in the X plus direction. Note that, in FIG. 9, a portion surrounded by an annular light color area indicates that the sound pressure is relatively high compared to that in the periphery thereof.

In FIG. 9, the portion at the center of the horizontal axis and at the lower end of the vertical axis is a portion closest to the opening 12. In FIG. 9, one light-colored annular area is observed in this portion. Further, the color changes to be gradually darker from the light-colored annular area toward the periphery.

FIG. 10 shows a simulation result obtained by three-dimensionally analyzing a sound pressure distribution in a plane intersecting the Pe axis in FIG. 5 when ultrasonic waves are transmitted from the ultrasonic device 50a shown in FIG. 5. The horizontal axis of FIG. 10 indicates a position in the Pf direction in FIG. 5, and the vertical axis of FIG. 10 indicates a position in the X direction in FIG. 5.

In FIG. 10, the portion at the center of the horizontal axis and at the center of the vertical axis is a portion closest to the opening 12. In FIG. 10, one light-colored annular area is observed in this portion. Further, the color changes to be gradually darker from the light-colored annular area toward the periphery.

The simulation results shown in FIGS. 9 and 10 suggest the presence of a so-called unimodal sound pressure distribution because the sound pressure has a single peak. In the unimodal sound pressure distribution, the energy of the ultrasonic waves is easily concentrated on the peak portion. Therefore, the ultrasonic device 50a that can transmit ultrasonic waves with high sound pressure or the ultrasonic device 50b that can receive ultrasonic waves with high sensitivity can be realized. In the multi-feed detector 58, the S/N ratio (signal-to-noise ratio) of the reception signal can be improved, and thus the determination accuracy of multi-feed can be particularly improved.

FIG. 11 shows a simulation result illustrating propagation of ultrasonic waves transmitted from the opening 12 in a free space FS in the analyses shown in FIGS. 9 and 10.

In the simulation result shown in FIG. 11, it is observed that the ultrasonic waves having the unimodal sound pressure distribution propagate while maintaining the unimodal sound pressure distribution even in the free space FS. Therefore, the simulation result shown in FIG. 11 suggests that the sound pressure of the ultrasonic waves passing through the document P can be sufficiently increased by using the ultrasonic device 50a that satisfies the above Expression (6). Similarly, the simulation result suggests that the ultrasonic waves passing through the document P can be received with higher sensitivity by using the ultrasonic device 50b that satisfies the above Expression (6).

The waveguide 14 of the ultrasonic device 50a shown in FIG. 5 is designed to satisfy the above Expression (6). Therefore, the above simulation result supports the usefulness of satisfying the above Expression (6).

FIGS. 12 and 13 also show simulation results different from those described above. The simulation results shown in FIGS. 12 and 13 are obtained by analyzing sound pressure distributions of an ultrasonic device having a waveguide that does not satisfy the above Expression (6). FIGS. 12 and 13 are the same as FIGS. 9 and 10 except that the design conditions of the waveguide to be simulated are different.

The simulation results shown in FIGS. 12 and 13 suggest the presence of a so-called bimodal sound pressure distribution because there are two sound pressure peaks. In the bimodal sound pressure distribution, the energy in the peak portions is dispersed, and the sound pressure decreases.

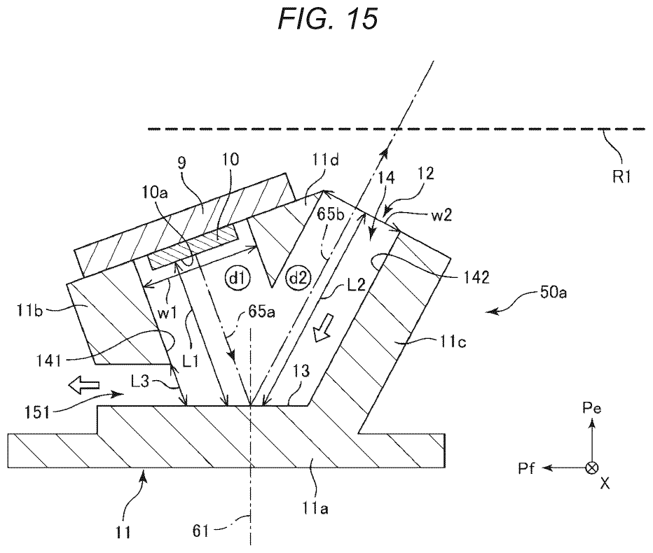

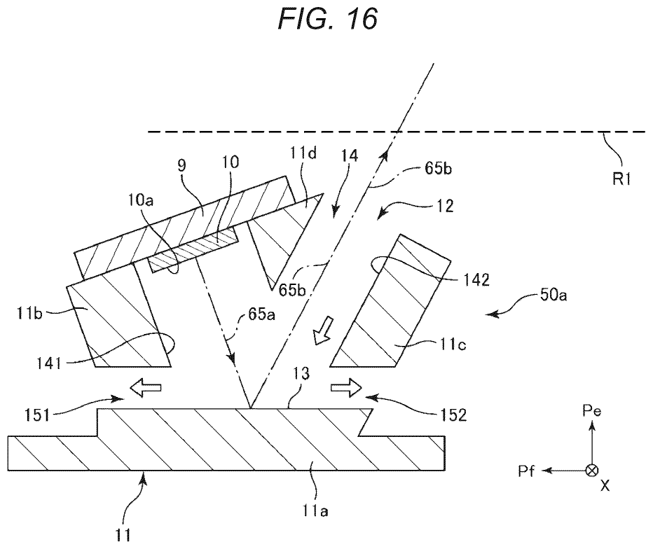

FIG. 14 shows a simulation result illustrating propagation of ultrasonic waves transmitted from an opening in a free space FS in the analyses shown in FIGS. 12 and 13.

In the simulation result shown in FIG. 14, it is observed that the ultrasonic waves having the bimodal sound pressure distribution propagate in the free space FS. As compared with the simulation result shown in FIG. 11, in the simulation result shown in FIG. 14, the ultrasonic waves are attenuated immediately after being emitted into the free space FS.

### 2. Second Embodiment

Next, an ultrasonic device according to a second embodiment will be described.

FIG. 15 is a side sectional view showing a configuration of the ultrasonic device 50a according to the second embodiment.

Hereinafter, the second embodiment will be described. In the following description, differences from the first embodiment will be mainly described, and substantially the same items will be omitted. In FIG. 15, the same configurations as those of the first embodiment have the same signs.

The ultrasonic device 50a shown in FIG. 15 is the same as the ultrasonic device 50a shown in FIG. 5 except that the configuration of the housing 11 is different. The configuration of the ultrasonic device 50a described later is also applicable to the ultrasonic device 50b.

The housing 11 shown in FIG. 15 has a first ejection hole 151. The first ejection hole 151 may be provided at a position different from that of the opening 12 of the housing 11, and is provided in the first wall 11b in FIG. 15. In particular, in FIG. 15, the first ejection hole 151 is provided so as to penetrate a portion of the first wall 11b adjacent to the base portion 11a. Accordingly, the first ejection hole 151 faces the reflection surface 13, and thus, even when foreign matter enters from the opening 12 as indicated by a white arrow in FIG. 15, the foreign matter is easily ejected through the first ejection hole 151. Specifically, by blowing air toward the opening 12 by an air duster or the like (not illustrated), the foreign matter can be easily ejected from the first ejection hole 151 on the airflow. As a result, the ultrasonic device 50a in which foreign matter is less likely to adhere to the transmission and reception surface 10a of the ultrasonic element 10 can be realized.

It is preferable that the cross-sectional shape (cross-sectional shape along a plane orthogonal to the Pf axis) of the first ejection hole 151 illustrated in FIG. 15 is horizontally long in the X direction along the reflection surface 13. Accordingly, the foreign matter deposited on the reflection surface 13 is more efficiently ejected through the first ejection hole 151.

Note that the placement of the first ejection hole 151 is not limited to the above-described position, and may be any position as long as the foreign matter entering the waveguide 14 can be ejected. As a result, an effect that the foreign matter can be easily ejected through the first ejection hole 151 is obtained.

Hereinafter, an example of a design procedure of the waveguide 14 provided with the first ejection hole 151 will be described. In the following description, in the width D of the model M described above, the length in the direction orthogonal to the central axis 65a in the cross section shown in FIG. 15 is referred to as “width w1”, and the length in the direction orthogonal to the central axis 65b is referred to as “width w2”. In the width D, the length in the direction orthogonal to the cross section of FIG. 15 on the central axis 65a in FIG. 15 is referred to as “depth d1”, and the length in the direction orthogonal to the cross section in FIG. 15 on the central axis 65b of FIG. 15 is referred to as “depth d2”. Further, in the length L, the length of the central axis 65a in FIG. 15 is referred to as “length L1”, and the length of the central axis 65b in FIG. 15 is referred to as “length L2”.

First, the depths d1 and d2 are temporarily determined in accordance with the size of the ultrasonic element 10. The depths d1 and d2 are preferably, for example, longer than one time and less than three times the length of the ultrasonic element 10 in the extension direction.

Then, first temporary lengths L1 and L2 are calculated by the above Expressions (1) to (6) based on the depths d1 and d2. It is assumed that the reflection surface 13 is located immediately after the interference point i1 illustrated in FIG. 8.

Then, the widths w1 and w2 are temporarily set to the same values as those of the depths d1 and d2. Then, second temporary lengths L1 and L2 are calculated by the above Expressions (1) to (6) based on the temporarily set widths w1 and w2.

Then, the length L1 is determined by averaging the first temporary length L1 and the second temporary length L1. Similarly, the length L2 is determined by averaging the first temporary length L2 and the second temporary length L2.

Then, optimal widths w1 and w2 are obtained by a simulation with respect to a value obtained by subtracting an opening length L3 of the first ejection hole 151 from the determined length L1 (difference L1−L3) and the determined length L2. In the simulation, a value at which a unimodal sound pressure distribution as illustrated in FIGS. 9 and 10 is obtained is estimated while changing the widths w1 and w2. The opening length L3 may be, for example, a length such that a cleaning tool enters the first ejection hole 151, and may be, for example, from about 2 mm to 5 mm.

Then, the widths w1 and w2 estimated by the simulation are compared with the temporarily determined widths w1 and w2. The simulation is repeated until the difference between the estimated widths becomes equal to or less than 1% of the temporarily determined w1 and w2. Then, the widths w1 and w2 when the simulation is finished are set as determined values.

In the above-described manner, the widths w1 and w2, the depths d1 and d2, and the lengths L1 and L2 are obtained.

When the lengths L1 and L2 are changed during the simulation, the lengths may be compared with the lengths L1 and L2 determined before the simulation. In this case, the simulation may be repeated until the difference between the lengths becomes equal to or less than 1% of the lengths L1 and L2 determined before the simulation. Then, the lengths L1 and L2 when the simulation is finished may be set as the determined values.

In the second embodiment described above, the same effects as those of the first embodiment can be obtained.

### 3. Third Embodiment

Next, an ultrasonic device according to a third embodiment will be described.

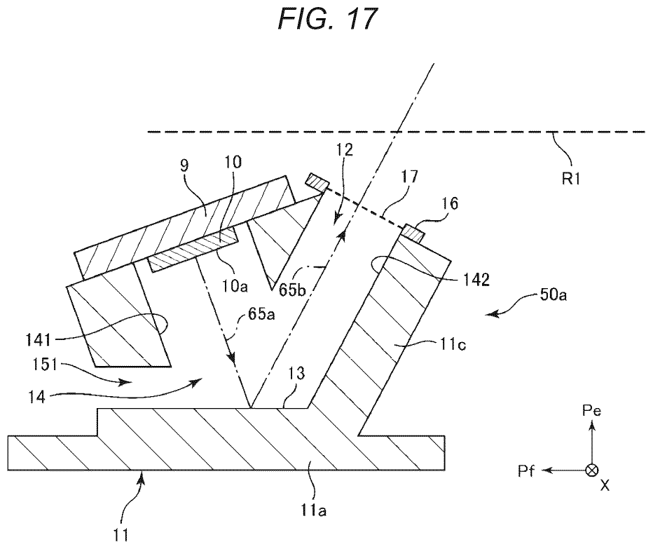

FIG. 16 is a side sectional view showing a configuration of the ultrasonic device 50a according to the third embodiment.

Hereinafter, the third embodiment will be described. In the following description, differences from the second embodiment will be mainly described, and substantially the same items will be omitted. In FIG. 16, the same configurations as those of the second embodiment have the same signs.

The ultrasonic device 50a shown in FIG. 16 is the same as the ultrasonic device 50a shown in FIG. 15 except that the configuration of the housing 11 is different. The configuration of the ultrasonic device 50a described later is also applicable to the ultrasonic device 50b.

The housing 11 shown in FIG. 16 has a second ejection hole 152. The second ejection hole 152 may be provided at a position different from those of the opening 12 and the first ejection hole 151, and is provided in the second wall 11c in FIG. 16. In particular, in FIG. 16, the second ejection hole 152 is provided so as to penetrate a portion of the second wall 11c adjacent to the base portion 11a. Accordingly, the second ejection hole 152 faces the reflection surface 13, and thus, even when foreign matter enters from the opening 12 as indicated by a white arrow in FIG. 16, the foreign matter can be more easily ejected through the first ejection hole 151 or the second ejection hole 152. As a result, the ultrasonic device 50a in which foreign matter is particularly unlikely to adhere to the transmission and reception surface 10a of the ultrasonic element 10 can be realized.

It is preferable that the cross-sectional shape (cross-sectional shape along a plane orthogonal to the Pf axis) of the second ejection hole 152 illustrated in FIG. 16 is horizontally long in the X direction along the reflection surface 13. Accordingly, the foreign matter deposited on the reflection surface 13 is more efficiently ejected through the second ejection hole 152.

Note that the placement of the second ejection hole 152 is not limited to the above-described position, and may be any position as long as the foreign matter entering the waveguide 14 can be ejected.

In the third embodiment described above, the same effects as those of the second embodiment can be obtained.

### 4. Fourth Embodiment

Next, an ultrasonic device according to a fourth embodiment will be described.

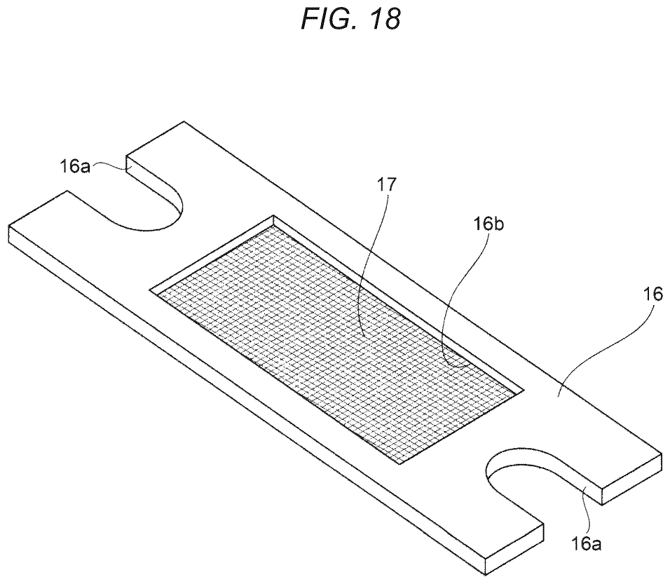

FIG. 17 is a side sectional view showing a configuration of the ultrasonic device 50a according to the fourth embodiment.

Hereinafter, the fourth embodiment will be described. In the following description, differences from the first embodiment will be mainly described, and substantially the same items will be omitted. In FIG. 17, the same configurations as those of the first embodiment have the same signs.

The ultrasonic device 50a shown in FIG. 17 is the same as the ultrasonic device 50a shown in FIG. 5 except that a protector 17 is added. The configuration of the ultrasonic device 50a described later is also applicable to the ultrasonic device 50b.

The ultrasonic device 50a shown in FIG. 17 includes the mesh-like protector 17 provided in the opening 12.

FIG. 18 is a perspective view of the protector 17 shown in FIG. 17. The protector 17 shown in FIG. 18 is attached to a support frame 16. The support frame 16 is a resin frame having a rectangular outer shape, and has a rectangular opening 16b. The opening 16b is set to be slightly larger than the opening 12. The protector 17 is attached to the opening 16b of the support frame 16. Both short sides of the support frame 16 are provided with cutout holes 16a for fastening by screws. The support frame 16 can be fixed to the opening 12 by using the cutout holes 16a as screw holes. Thus, the protector 17 can be attached so as to close the opening 12.

The protector 17 is, for example, a filter formed in a mesh shape by arranging wires to intersect one another. Examples of the wires include a resin material such as polyester, and a metal material such as copper, iron, brass, and SUS.

Since the ultrasonic device 50a includes the first ejection hole 151, fine foreign matter passing through the protector 17 and entering the waveguide 14 can be easily cleaned. Therefore, the protector 17 is required to have a function of preventing entry of large foreign matter. Therefore, as the protector 17, a filter having a coarse mesh such that adhesion of foreign matter or the like is less likely to occur when cleaned with a cleaning liquid is preferably used.

In the fourth embodiment described above, the same effects as those of the second embodiment can be obtained.

### 5. Effects Exerted by Embodiments

As described above, each of the ultrasonic devices 50a and 50b according to the embodiments includes the ultrasonic element 10 and the housing 11. The ultrasonic element 10 has the ultrasonic wave transmission and reception surface 10a that performs at least one of transmission of ultrasonic waves and reception of ultrasonic waves. The housing 11 houses the ultrasonic element 10. The housing 11 includes the reflection surface 13, the waveguide 14, and the opening 12. The reflection surface 13 reflects ultrasonic waves. The waveguide 14 propagates ultrasonic waves. The opening 12 is provided at one end of the waveguide 14, and the ultrasonic waves pass through the opening. The length L of the waveguide 14 is longer than the width D of the waveguide 14.

According to the configuration, the ultrasonic device 50a that can transmit ultrasonic waves with high sound pressure or the ultrasonic device 50b that can receive ultrasonic waves with high sensitivity, in which foreign matter is unlikely to adhere to the ultrasonic wave transmission and reception surface 10a can be realized.

In the ultrasonic devices 50a and 50b according to the embodiments, when the length of the waveguide 14 is L, the propagation angle of the ultrasonic wave propagating through the waveguide 14 is a, and the wavelength of the ultrasonic wave is A, it is preferable to satisfy the following Expression (6).

$$0.9 \times \frac{cos α}{1 - cos α} k λ ≦ L ≦ 1.1 \times \frac{cos α}{1 - cos α} k λ \qquad ( 6 )$$

In the above Expression (6), k is an integer.

According to the configuration, the probability of occurrence of a strengthening interference in the opening 12 can be particularly increased. Accordingly, the ultrasonic device 50a that can transmit ultrasonic waves with higher sound pressure or the ultrasonic device 50b that can receive ultrasonic waves with higher sensitivity can be realized.

In the ultrasonic devices 50a and 50b according to the embodiments, the width D of the waveguide 14 is preferably one fifth or less of the length L of the waveguide 14.

According to the configuration, the propagation angle α falls within an appropriate range, and thus the ultrasonic device 50a that can transmit ultrasonic waves with high sound pressure in the vicinity of the opening 12 or the ultrasonic device 50b that can receive ultrasonic waves with high sensitivity can be realized.

In the ultrasonic devices 50a and 50b according to the embodiments, the reflection surface 13 is preferably provided on the central axis 65a (the perpendicular line of the transmission and reception surface 10a).

According to the configuration, the probability that the ultrasonic waves emitted from the ultrasonic element 10 are reflected by the reflection surface 13 and emitted from the opening 12 can be increased.

In the ultrasonic devices 50a and 50b according to the embodiments, the reflection surface 13 is disposed in the middle of the waveguide 14. The waveguide 14 includes the first portion 141 and the second portion 142. The first portion 141 extends from the ultrasonic element 10 to the reflection surface 13 along the central axis 65a (the perpendicular line of the transmission and reception surface 10a). The second portion 142 extends from the reflection surface 13 to the opening 12 along the central axis 65b (the perpendicular line of the opening 12). The length of the first portion 141 in the extension direction of the central axis 65a is preferably longer than the width of the first portion 141. The length of the second portion 142 in the extension direction of the central axis 65b is preferably longer than the width of the second portion 142.

According to the configuration, attenuation of the ultrasonic waves is easily suppressed in both the first portion 141 and the second portion 142. Therefore, the ultrasonic device 50a that can transmit ultrasonic waves with higher sound pressure or the ultrasonic device 50b that can receive ultrasonic waves with higher sensitivity can be realized.

In the ultrasonic devices 50a and 50b according to the embodiments, the normal line 61 of the reflection surface 13 is preferably inclined with respect to both the central axis 65a (the perpendicular line of the transmission and reception surface 10a) and the central axis 65b (the perpendicular line of the opening 12).

According to the configuration, the probability that the ultrasonic waves emitted from the ultrasonic element 10 shown in FIG. 5 are reflected by the reflection surface 13 and emitted from the opening 12 can be increased. Further, the probability that the ultrasonic waves reflected by the reflection surface 13 return to the ultrasonic element 10 can be reduced. Accordingly, the sound pressure of the ultrasonic waves emitted from the opening 12 can be sufficiently increased.

In the ultrasonic devices 50a and 50b according to the embodiments, it is preferable that the central axis 65a (the perpendicular line of the transmission and reception surface 10a) and the central axis 65b (the perpendicular line of the opening 12) are inclined in opposite directions to each other with respect to the normal line 61 of the reflection surface 13.

According to the configuration, the ultrasonic waves emitted from the ultrasonic element 10 shown in FIG. 5 and reflected by the reflection surface 13 can be emitted from the opening 12 with suppressed attenuation.

In the ultrasonic devices 50a and 50b according to the embodiments, it is preferable that the central axis 65a (the perpendicular line of the transmission and reception surface 10a) and the central axis 65b (the perpendicular line of the opening 12) intersect each other on the reflection surface 13.

According to the configuration, for example, when the ultrasonic waves propagating along the central axis 65a are reflected by the reflection surface 13, the reflection efficiency can be sufficiently increased.

In the ultrasonic devices 50a and 50b according to the embodiments, it is preferable that the central axis 65b (the perpendicular line of the opening 12) is inclined with respect to the document P irradiated with ultrasonic waves (an object to be irradiated).

According to the configuration, multiple reflection of ultrasonic waves between the document P and the ultrasonic devices 50a and 50b can be suppressed.

In the ultrasonic devices 50a and 50b according to the embodiments, the housing 11 may have the first ejection hole 151 provided at a position different from that of the opening 12.

According to the configuration, an effect that foreign matter can be easily ejected through the first ejection hole 151 is obtained.

In the ultrasonic devices 50a and 50b according to the embodiments, the housing 11 may have the second ejection hole 152 provided at a position different from that of the opening 12 and the first ejection hole 151.

According to the configuration, an effect that foreign matter can be more easily ejected through the first ejection hole 151 or the second ejection hole 152 is obtained.

The ultrasonic devices 50a and 50b according to the embodiments may include the mesh-like protector 17 provided in the opening 12.

According to the configuration, the protector 17 can prevent entry of large foreign matter.

The multi-feed detector 58 according to the embodiments includes the transmission ultrasonic device that is the ultrasonic device 50a according to the embodiments, in which the transmission and reception surface 10a transmits ultrasonic waves, and the reception ultrasonic device that is the ultrasonic device 50b according to the embodiments, in which the transmission and reception surface 10a receives ultrasonic waves. The transmission ultrasonic device and the reception ultrasonic device are disposed with the document conveyance route (the conveyance route of the document P (medium)) in between. Further, the ultrasonic waves are transmitted from the transmission ultrasonic device, the ultrasonic waves passing through the document P are received by the reception ultrasonic device, and the multi-feed of the documents P is detected based on the intensity of the reception signal.

According to the configuration, the multi-feed detector 58 with high determination accuracy of multi-feed in which foreign matter is unlikely to adhere to the ultrasonic wave transmission and reception surface 10a and maintenance is easy in the ultrasonic devices 50a and 50b can be obtained.

The conveying device 95 according to the embodiments includes the multi-feed detector 58 according to the embodiments, and conveys the document P along the document conveyance route (the conveyance route of the document P (medium)).

According to the configuration, the conveying device 95 having excellent maintainability high determination accuracy of multi-feed can be realized.

The scanner 100 according to the embodiments includes the conveying device 95 according to the embodiments, and the reader (first reader 32 and second reader 33) that reads an image attached to the document P (medium).

According to the configuration, the scanner 100 having excellent maintainability, high determination accuracy of multi-feed, and excellent handleability can be realized.

Although the ultrasonic device, the multi-feed detector, the conveying device, and the scanner according to the present disclosure have been described based on the illustrated embodiments, the present disclosure is not limited thereto.

For example, in the ultrasonic device, the multi-feed detector, the conveying device, and the scanner of the present disclosure, each unit of the embodiments may be replaced with any configuration having the same function, or any configuration may be added to the embodiments.

The ultrasonic device of the present disclosure can also be applied to another electronic apparatus than the scanner. For example, in a printing apparatus (printer) including a printing head that prints an image on a sheet conveyed on a conveyance route, the multi-feed detector using the ultrasonic device of the present disclosure may be applied for detection of multi-feed of media. According to the configuration, the same effects as those of the above-described embodiments can be obtained.

What is claimed is:

1. An ultrasonic device comprising:
an ultrasonic element having an ultrasonic wave transmission and reception surface that performs at least one of transmission of ultrasonic waves and reception of ultrasonic waves; and
a housing that houses the ultrasonic element, wherein
the housing has
a reflection surface that reflects the ultrasonic waves,
a waveguide that propagates the ultrasonic waves, and
an opening provided at one end of the waveguide, through which the ultrasonic waves pass, and
a length of the waveguide is longer than a width of the waveguide.

2. The ultrasonic device according to claim 1, wherein
the following expression is satisfied, wherein a length of the waveguide is L, a propagation angle of the ultrasonic waves propagating through the waveguide is α, a wavelength of the ultrasonic waves is λ, and k is an integer.
$$0.9 \times \frac{cos α}{1 - cos α} k λ ≦ L ≦ 1.1 \times \frac{cos α}{1 - cos α} k λ$$

3. The ultrasonic device according to claim 1, wherein
the width of the waveguide is one fifth or less of the length of the waveguide.

4. The ultrasonic device according to claim 1, wherein
the reflection surface is provided on a perpendicular line of the transmission and reception surface.

5. The ultrasonic device according to claim 1, wherein
the reflection surface is disposed in the middle of the waveguide,
the waveguide has
a first portion extending from the ultrasonic element to the reflection surface along a perpendicular line of the transmission and reception surface, and
a second portion extending from the reflection surface to the opening along a perpendicular line of the opening,
a length of the first portion in a direction of the perpendicular line of the transmission and reception surface is longer than a width of the first portion, and
a length of the second portion in a direction of the perpendicular line of the opening is longer than a width of the second portion.

6. The ultrasonic device according to claim 5, wherein
a normal line of the reflection surface is inclined with respect to both the perpendicular line of the transmission and reception surface and the perpendicular line of the opening.

7. The ultrasonic device according to claim 6, wherein
the perpendicular line of the transmission and reception surface and the perpendicular line of the opening are inclined in opposite directions with respect to the normal line of the reflection surface.

8. The ultrasonic device according to claim 7, wherein
the perpendicular line of the transmission and reception surface and the perpendicular line of the opening intersect each other on the reflection surface.

9. The ultrasonic apparatus according to claim 5, wherein
the perpendicular line of the opening is inclined with respect to an object to be irradiated with the ultrasonic waves.

10. The ultrasonic device according to claim 1, wherein
the housing has a first ejection hole provided at a position different from that of the opening.

11. The ultrasonic device according to claim 10, wherein
the housing has a second ejection hole provided at a position different from that of the opening and the first ejection hole.

12. The ultrasonic apparatus according to claim 10, further comprising a mesh-like protector provided in the opening.

13. A multi-feed detector comprising:
a transmission ultrasonic device comprising:
an ultrasonic element having an ultrasonic wave transmission and reception surface that performs at least one of transmission of ultrasonic waves and reception of ultrasonic waves; and
a housing that houses the ultrasonic element, wherein
the housing has
a reflection surface that reflects the ultrasonic waves,
a waveguide that propagates the ultrasonic waves, and
an opening provided at one end of the waveguide, through which the ultrasonic waves pass, and
a length of the waveguide is longer than a width of the waveguide, the transmission and reception surface transmitting ultrasonic waves; and
a reception ultrasonic device comprising:
an ultrasonic element having an ultrasonic wave transmission and reception surface that performs at least one of transmission of ultrasonic waves and reception of ultrasonic waves; and
a housing that houses the ultrasonic element, wherein
the housing has
a reflection surface that reflects the ultrasonic waves,
a waveguide that propagates the ultrasonic waves, and
an opening provided at one end of the waveguide, through which the ultrasonic waves pass, and
a length of the waveguide is longer than a width of the waveguide, the transmission and reception surface receiving the ultrasonic waves, wherein
the transmission ultrasonic device and the reception ultrasonic device are disposed with a conveyance route of a medium in between, and
the ultrasonic waves are transmitted from the transmission ultrasonic device, the ultrasonic waves passing through the medium are received by the reception ultrasonic device, and multi-feed of the media is detected based on intensity of a reception signal.

14. A conveying device comprising the multi-feed detector according to claim 13, and conveying the medium along the conveyance route of the medium.

15. A scanner comprising:
the conveying device according to claim 14; and
a reader that reads an image attached to the medium.
